(19) United States
(12) Patent Application Publication
(10) Pub. No.: US 2011/0074273 A1
(43) Pub. Date: Mar. 31, 2011

(54) Explosion Protection System for a High Pressure Lamp

(76) Inventor: Josef Kroell, Potsdam (DE)

(21) Appl. No.: 12/995,179

(22) PCT Filed: May 29, 2008
(86) PCT No.: PCT/EP2008/056577

§ 371 Date: Nov. 29, 2010

(51) Int. Cl. H01K 1/26; H01J 19/54

(52) U.S. Cl. 313/113; 313/312

(57) ABSTRACT

A base for a high pressure lamp, such base having lateral walls enclosing the lamp bulb. Also disclosed are lateral walls for a base, and a lamp system comprising such base.

### TECHNICAL FIELD

The present invention relates to a base for a high-pressure lamp and to a lamp arrangement with such a base.

### PRIOR ART

High-pressure lamps have a lamp vessel which is filled with a gaseous medium. In particular during operation, pressures of from typically a few bar to a few hundred bar arise within the lamp vessel. This relates inter alia to some halogen incandescent lamp types and in particular to high-pressure discharge lamps. The latter have, for example, a discharge bulb with an anode and cathode arranged therein, with an arc being produced between said anode and cathode during operation via a gas discharge. In addition, there are also high-pressure discharge lamps for AC operation, i.e. with two identical electrodes and an electrode-less discharge lamp, for example, with microwave excitation. In any case, the lamp vessel preferably consists of quartz glass or glass ceramic and is designed to withstand pressures of sometimes 300 bar or more. Nevertheless, owing to the extreme loads to which these lamps are subjected, material fatigue may arise, which can result in explosion-like bursting of the lamp vessel. Owing to the high pressure prevailing in the lamp vessel, the energy released in the event of the lamp bursting is so high that the immediate vicinity is adversely affected by the impinging vessel fragments. Many conventional high-pressure lamps also have a reflector around the lamp vessel, with one end of said reflector being formed so as to be closed and with a light exit opening being provided at the other end of said reflector. In the event of the lamp bursting, vessel fragments can even destroy the reflector, with the result that the number of splintered objects is increased. In addition, the reflector fragments are much larger than the vessel fragments, with the result that the direct vicinity is endangered not only by the vessel fragments, but also by the large fragments of the reflector. In this case, the direct vicinity can be a projection device or another machine, but it is also possible for humans to be at direct risk. In order to protect the environment in the direction remote from the reflector opening, the reflector is therefore generally reinforced by an additional element, which is in direct contact with the reflector. This may be a metal grid which is positioned around the reflector, or an additional cap, which is adhesively bonded to the reflector fixedly.

However, these protective measures have a few disadvantages. Firstly, in the case of the metal grid, complete protection is not ensured since the base is not completely covered. Secondly, in the case of the additional cap, said cap is connected fixedly to the reflector, which may result in a breakage of the reflector also causing a breakage of the protective cap. In addition, in this case, the materials used need to have similar thermal properties since otherwise mechanical stresses may occur which damage the lamp. However, this also means that sometimes only very unstable materials can be used, which do not make it possible to effectively prevent breakage of the reflector.

### DESCRIPTION OF THE INVENTION

The object of the present invention is therefore to provide a high-pressure lamp which has improved protection in the event of bursting of the lamp vessel.

This object is achieved by virtue of the fact that a base for such a high-pressure lamp is formed with side walls, which surround the high-pressure lamp in the form of a protective cap.

Advantageously, the side walls in the form of a protective cap can be formed integrally with the base, but it is also possible for the side walls to be in the form of a separate protective cap element, which can be connected to the base. A connection to the base can in this case be performed by means of adhesive bonding, cementing, clamping, screwing or plugging, for example.

It is critical, both in the case of the integral formation and in the case of the connectable formation, that the side walls are connected to the base, but not to the reflector. Since there is therefore no direct contact between the reflector and the side walls, it is also not possible for any thermal stresses to occur when using different materials. As a result, considerably more stable materials can be used for forming the side wall, for example, such as ceramic, for example. It is particularly advantageous if, precisely in the case of the integral formation of the side wall with the base, the side walls consist of the ceramic material of the base.

The formation of the protective cap as a separate element also has the advantage that existing lamp arrangements are also equipped with such a side wall, with the result that already existing lamp arrangements can also be provided with improved explosion protection.

The contactless arrangement of the protective cap and the reflector also has the advantage that, in the event of the lamp bursting, which may occur, the reflector can absorb a large portion of the energy in the form of a breakage or a deformation without directly damaging the protective cap. The remaining energy or the reflector fragments can then easily be captured by the protective cap.

A risk to humans and machines as a result of lamp or reflector fragments is thus reduced in a direction remote from the reflector opening in the event of a lamp bursting. In order, in addition, to prevent lamp or reflector fragments from emerging in the direction of the light exit opening of the reflector and the protective cap, the reflector can additionally be covered by a transparent protective disk.

Particularly advantageous here is an exemplary embodiment in which the transparent protective disk has a first and a second disk element, the second disk element, which is arranged on the lamp side, being designed to capture a large proportion of the kinetic energy of lamp or reflector fragments in the event of a breakage. As a result of the breakage of the second disk element, so much kinetic energy can be converted that the remaining lamp fragments can be captured easily by the remaining first disk element.

Advantageously, the first and second disk elements can each be connected individually to the reflector. However, it is also possible for the transparent protective disk to be connected to the protective cap or the side walls of the base, as a result of which the protective disk still retains its protective function even in the event of a breakage of the reflector. In this case, the first and second disk elements can be arranged directly one on top of the other or spaced apart from one another.

However, it is also advantageous, as is shown by a further exemplary embodiment, that the disks are connected directly to one another, for example by means of adhesive bonding, as a result of which only the first disk element needs to be connected to the reflector. Instead of a direct contact between the first and second disk elements, the first and second disk elements can also be connected to one another by means of spacers, as a result of which an air space remains between the disk elements.

If it is only necessary for the first disk element to be connected to the reflector, advantageously already existing lamps can be equipped with the cover disk according to the invention for reflectors, with the result that already existing lamps also have improved explosion protection.

Further advantages and advantageous embodiments are defined in the dependent claims, the description and the drawings.

Particularly advantageous configurations are given in the dependent claims.

### BRIEF DESCRIPTION OF THE DRAWINGS

The invention will be explained in more detail below with reference to exemplary embodiments. In the figures:

FIG. 1 shows a first exemplary embodiment of the lamp arrangement according to the invention;

FIG. 2 shows a second embodiment of the lamp arrangement according to the invention; and

FIG. 3 shows a third exemplary embodiment of the lamp arrangement according to the invention.

### PREFERRED EMBODIMENT OF THE INVENTION

Identical or functionally similar elements are denoted by the same reference symbols in the text which follows.

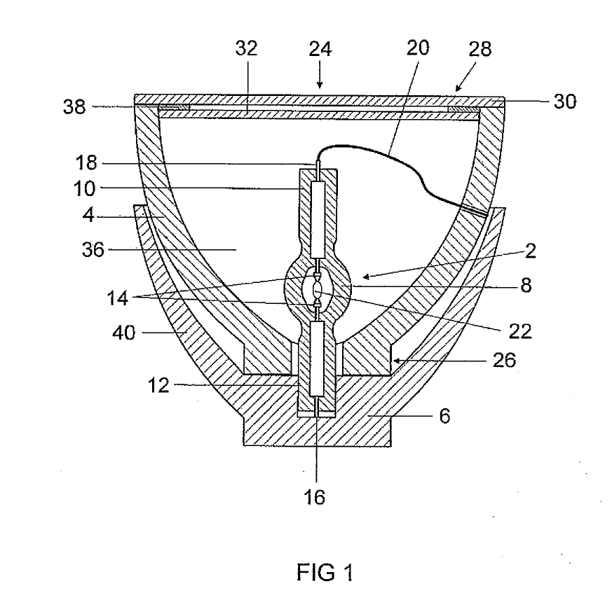

FIG. 1 shows a schematic illustration of a first preferred exemplary embodiment of the lamp arrangement according to the invention. Such a lamp arrangement has a discharge burner 2, which is surrounded by a reflector 4 and is accommodated by a base 6. The discharge burner itself has a discharge vessel or bulb 8 which is filled with a discharge gas and which is sealed in an air-tight manner via two sealing regions, for example pinch-sealing regions, 10 and 12. The electrode 14, whose free end reaches into the bulb 8, is embedded in the pinch-sealing regions 10 and 12. In the pinch-sealing region 10, 12, the electrodes are generally connected to power supply line elements 16, 18 via fuse-sealed molybdenum foils, the power supply line element 16 making electrical contact with the base 6, while the power supply line element 18 is passed over a power supply line 20 through the reflector 4.

By applying a voltage between the electrodes 14, an arc 22 is formed, as a result of gas discharge, between the electrodes, the light of said arc being emitted by means of the reflector 4 in the direction of a light exit opening 24. For this purpose, it is advantageous if the arc 22 is arranged at the focal point of the reflector 4. In this case, the reflector can preferably have an elliptical, parabolic or differently shaped formation. On its side 26 remote from the light exit opening, the reflector 4 is connected to the base 6.

The light exit opening 24 is sealed off by a transparent protective disk 28, which has a first disk element 30 and a second disk element 32.

In the event that the discharge burner 2 bursts as a result of the extreme load and material fatigue, parts, i.e. burner fragments, are flung into the reflector interior 36 and hit firstly the reflector inner wall and secondly the second disk element 32. As a result of the high kinetic energy with which the burner fragments impinge upon the reflector and the second disk element, as a result of a pressure of over 200 bar, for example, in the bulb 8, breakage of the second disk element may occur, as a result of which the kinetic energy of the burner fragments is absorbed. As a result of the energy conversion, only those fragments which have a much lower kinetic energy impinge on the first disk element 30, with the result that the first disk element 30 does not experience any breakage and the burner fragments and fragments of the second disk element 32 remain in the reflector interior 36 and therefore cannot endanger the direct vicinity.

Since, as a result of the high kinetic energy which is produced in the event of explosion-like bursting of the burner, not only the covering disk 28, but also the reflector 4, are at risk of breakage, the reflector can be surrounded in contact-free fashion by an additional element by virtue of the base 6 having integrally formed or attachable side walls 40, which surround the entire circumference of the reflector, preferably at least in the region of the bulb 8. These side walls 40 form a protective cap, which is connected fixedly to the base and which can capture any reflector fragments produced. Preferably, the protective cap thus formed also consists of the stable ceramic of the base. Since the reflector and the protective cap are not connected directly to one another, it is firstly possible that a breakage of the reflector does not result in breakage of the protective cap, and secondly it is possible for materials to be used whose thermal properties can be different from those of the reflector, without mechanical stresses occurring between the protective cap and the reflector which damage the reflector. As a result, much more stable materials can be used as the material for the protective cap.

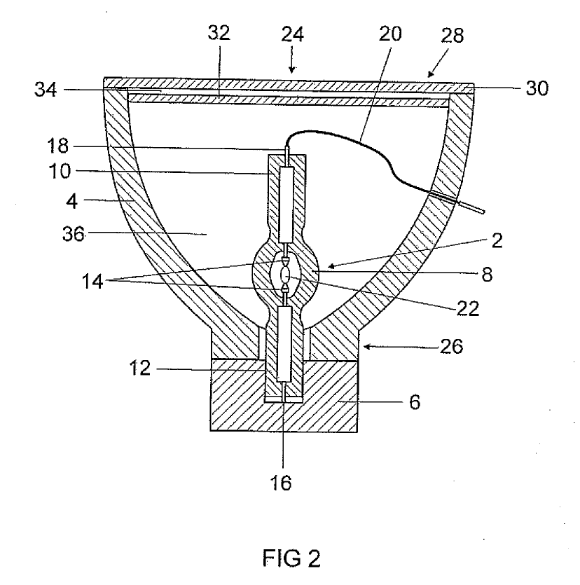

As illustrated in FIG. 1, the first and second disk elements can also be separated from one another by an air gap 34. For this purpose, as is illustrated schematically in FIG. 1, spacers 38 can be provided which are arranged between the first disk element 30 and the second disk element 32, are connected to the first and second disk elements 30; 32 and keep the disk elements at a defined distance from one another. The covering disk formed in this way can be connected either to the reflector 4 or advantageously to the side walls 40 (not illustrated), wherein, in the exemplary embodiment illustrated in FIG. 1, only one of the disk elements is to be connected to the reflector or the protective cap, with the result that a covering disk according to the invention formed in this way can easily be used in the case of already existing lamps. Instead of connecting the first and second disk elements via a spacer, it is possible for the two disk elements to also be connected directly to the reflector or the side walls (not illustrated), as shown in FIG. 2.

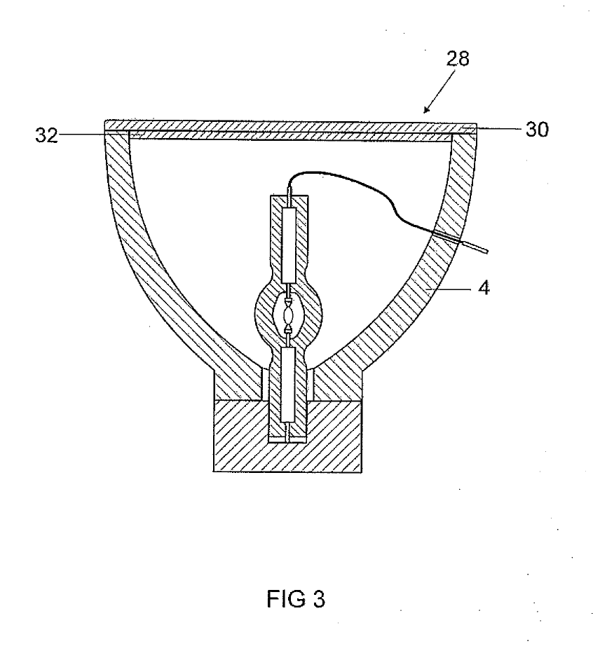

Instead of a protective disk 28, which consists of two first and second disk elements which are formed separately from one another and are connected to the reflector 4 or the side walls, it is possible for the first and second disk elements to be in direct contact with one another, as shown in FIG. 3. For example, the covering disk 28 according to the invention can be formed by virtue of the first and second disk elements 30, 32 being adhesively bonded one on top of the other. As can furthermore be seen from FIG. 2, with such a design of the protective disk 28, it is likewise possible for the protective disk to be connected to the reflector 4 or the side walls only once with respect to one of the two elements, in this case the first disk element. Such a protective disk has the advantage that already existing high-pressure lamps can be equipped with protective disks according to the invention.

Although the invention has been explained above using the example of a high-pressure discharge lamp, the invention is not restricted to this type of lamp. Instead, the advantages according to the invention can also be achieved with other high-pressure lamp types, for example with halogen incandescent lamps with a high fill pressure.

The invention discloses a base for a high-pressure lamp, which has side walls which surround the lamp bulb, such side walls for a base, and a lamp arrangement with such a base.

1. A base for a high-pressure lamp, wherein the base has side walls, which are configured to surround the high-pressure lamp in the form of a protective cap.

2. The base as claimed in claim 1, wherein the side walls are formed integrally with the base.

3. The base as claimed in claim 1, wherein the side walls are in the form of elements which can be connected to the base.

4. The base as claimed in claim 3, wherein the connection is formed by plugging, screwing, clamping, cementing or adhesive bonding.

5. The base as claimed in claim 1, wherein the side walls are formed from ceramic and/or the material of the base.

6. The base as claimed in claim 1, wherein the side walls are formed in such a way that a reflector can be arranged between the high-pressure lamp and the side walls.

7. The base as claimed in claim 6, wherein the reflector can be connected to the base in such a way that an air gap remains between the reflector and the side wall.

8. A side wall for a base of a high-pressure lamp, which is shaped in the form of a protective cap and is formed such that it can be connected to the base.

9. The side wall as claimed in claim 8, wherein the connection is formed by plugging, screwing, clamping, cementing or adhesive bonding.

10. The side wall as claimed in claim 8, wherein the side walls are formed from ceramic and/or the material of the base.

11. The side wall as claimed in claim 8, wherein the side walls are formed in such a way that a reflector can be arranged between the high-pressure lamp and the side walls.

12. The side wall as claimed in claim 11, wherein the reflector can be connected to the base in such a way that an air gap remains between the reflector and the side wall.

13. A lamp arrangement with a lamp vessel, which is accommodated by a base, and with a reflector with a light exit opening, wherein one end of the reflector, which end is remote from the light exit, is connected to the base, wherein the base is formed as claimed in claim 1.

14. The lamp arrangement as claimed in claim 13, wherein the light exit opening of the reflector is closed by means of a transparent protective disk.

15. The lamp arrangement as claimed in claim 14, wherein the protective disk has a first and a second disk element, that disk element which is arranged on the burner side being designed to capture kinetic energy of a part impinging thereon via breakage.

16. The lamp arrangement as claimed in claim 13, wherein the first and/or second disk elements are connected to the reflector and/or the side walls.

17. The lamp arrangement as claimed in claim 13, wherein the first and second disk elements are in direct contact with one another.

18. The lamp arrangement as claimed in claim 13, wherein the first and second disk elements are adhesively bonded to one another.

19. The lamp arrangement as claimed in claim 13, wherein the first and second disk elements are arranged so as to be spaced apart from one another.

20. The lamp arrangement as claimed in claim 13, wherein a spacer element is arranged between the first and second disk elements and is connected to the first and second disk elements in such a way that there is an air gap between the first and second disk elements.

21. The lamp arrangement as claimed in claim 13, wherein the lamp vessel relates to a high-pressure discharge lamp.
